(19) United States
(12) Patent Application Publication
(10) Pub. No.: US 2004/0006759 A1
(43) Pub. Date: Jan. 8, 2004

(54) Method of dividing a semiconductor integrated circuit pattern

(76) Inventors: Chuen Huei Yang, Taipei City (TW); Chien-Ming Wang, Hsin-Chu Hsien (TW); Chien-Wen Lai, Taipei Hsien (TW); Cheng-Shyan Tsay, Hsin-Chu Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/064,356

(22) Filed: Jul. 4, 2002

(51) Int. Cl. G06F 17/50

(52) U.S. Cl. 716/20; 716/19

(57) ABSTRACT

A method of dividing a semiconductor integrated circuit pattern. The pattern has a plurality of cells with the same shape and a polygonal planar positioned between each cell, the polygonal planar has two parallel horizontal edges and a plurality of vertexes. The method includes depicting a division line to divide the polygonal planar positioned between each cell into a plurality of unit figures. The division line begins along a horizontal edge of the polygonal planar, and when meeting with a vertex, the division line extends a vertical line segment from the horizontal edge to another horizontal edge.

### BACKGROUND OF INVENTION

1. Field of the Invention

The present invention relates to a method of dividing a semiconductor integrated circuit pattern.

2. Description of the Prior Art

Recently, integrated circuit patterns are increasingly micronized and complicated along with the increasing packing density of semiconductor devices such as a dynamic random access memory (DRAM) or a microprocessor. A method of manufacturing photo mask patterns includes first forming an integrated circuit pattern by using a design tool such as a computer-aided design system (CAD system). The initial designed circuit pattern is then drawn or depicted on a photo mask by a writer of a charged particle beam drawing system.

The input graphic data of the writer can only use basic rectangles having comparatively simple limited shapes such as a rectangle, a trapezoid, and a parallelogram in order to represent a circuit pattern region subjected to charged particle beam pattern drawing. Generally, graphic data of an integrated circuit pattern created by a CAD system cannot be directly used as input graphic data of the writer. Consequently, a circuit pattern must be divided into several unit figures, which are then converted by a computer system into an input graphic data that is usable for the writer.

Please refer to FIG. 1 and FIG. 2. FIG. 1 and FIG. 2 are schematic diagrams of a prior art method of dividing circuit patterns. As shown in FIG. 1, a circuit pattern 10 comprises a plurality of cells 12 with the same shape and a polygonal planar 14 positioned between each cell. The polygonal planar 14 comprises two parallel horizontal edges and a plurality of vertexes. The prior art method first divides the polygonal planar 14 into a top portion 14a and a bottom portion 14b using a horizontal line 16. Because the writer can only use unit figures such as a triangle, rectangle, trapezoid, and parallelogram to draw the circuit pattern 10, a plurality of vertical line segments 18 must be formed at each vertex in the top 14a portion and the bottom 14b portion of the polygonal planar 14 so as to further divide the polygonal planar 14 into a plurality of unit figures.

Since the prior art method first uses a horizontal line to directly divide a polygonal planar into a top portion and a bottom portion which destroys the completeness of the polygonal planar, the polygonal planar is then divided into a plurality of unit figures by the vertical line segments formed at each vertex. As shown in FIG. 2, the polygonal planar 14 is divided into thirteen unit FIGS. 20 by the prior art method. Therefore, a writer must perform thirteen steps of charged beam shooting to respectively form the unit figures, and combining each unit figure completes the drawing of the polygonal planar. In other words, the prior art method results in more shot counts and more time spent when a writer drawing the polygonal planar is positioned between each cell of a circuit pattern. Furthermore, during the drawing process, a critical dimension (CD) of the polygonal planar is hard to control due to the prior art dividing method.

### SUMMARY OF INVENTION

It is therefore a primary objective of the claimed invention to provide a method of dividing a semiconductor integrated circuit pattern for solving the above-mentioned problems.

According to the claimed invention, a method of dividing a semiconductor integrated circuit pattern is provided. The pattern comprising a plurality of cells with the same shape and a polygonal planar positioned between each cell, the polygonal planar comprising two parallel horizontal edges and a plurality of vertexes. The method comprises depicting a division line to divide the polygonal planar positioned between each cell into a plurality of unit figures. The division line begins along a horizontal edge of the polygonal planar, and when meeting with a vertex, the division line extends a vertical line segment from the horizontal edge to another horizontal edge.

It is an advantage over the prior art that the method of dividing a semiconductor integrated circuit pattern according to the claimed invention uses horizontal edges and vertical line segments formed at each vertex to divide a polygonal planar. Consequently, the polygonal planar is divided into a small number of unit figures. Therefore, the disadvantage of the prior art method that results in more time spent when drawing the circuit pattern by a writer and causes the critical dimension to be hard to control can be improved.

These and other objectives of the claimed invention will no doubt become obvious to those of ordinary skill in the art after reading the following detailed description of the preferred embodiment, which is illustrated in the multiple figures and drawings.

### BRIEF DESCRIPTION OF DRAWINGS

FIG. 1 and FIG. 2 are schematic diagrams of a prior art method of dividing circuit patterns.

FIG. 3 is a schematic diagram of a method of dividing a semiconductor integrated circuit pattern according to the present invention.

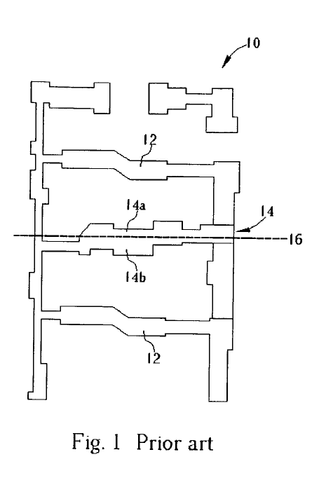

### DETAILED DESCRIPTION

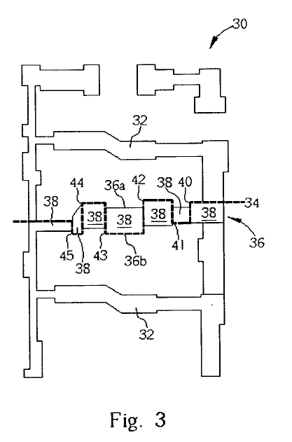

Please refer to FIG. 3. FIG. 3 is a schematic diagram of a method of dividing integrated circuit patterns. The dividing method according to the present invention is applied to convert a semiconductor circuit pattern data into input graphic data of a writer. Therefore, the writer is able to use the input graphic data to draw the circuit pattern on a photo mask or a substrate, such as a semiconductor wafer. As shown in FIG. 3, a circuit pattern 30 comprises a plurality of cells 32 with the same shape and a polygonal planar 36 positioned between each cell. The polygonal planar 36 comprises two parallel horizontal edges 36a, 36b and a plurality of vertexes.

The dividing method according to the present invention depicts a dividing line 34 to divide the polygonal planar 36 into a plurality of unit FIGS. 38. The dividing line 34 begins along a horizontal edge 36a of the polygonal planar 36. When meeting with vertex 40, the dividing lines 34 extends a vertical line segment to another horizontal edge 36b. Then the dividing line 34 is depicted along the horizontal edge 36b until vertex 41, when another vertical line segment is extended form the horizontal edge 36b to the horizontal edge 36a. Then the dividing line 34 is depicted along the horizontal edge 36a until vertex 42, when another vertical line segment is extended form the horizontal edge 36a to the horizontal edge 36b. Then the dividing line 34 is depicted along the horizontal edge 36b until vertex 43, when another vertical line segment is extended form the horizontal edge 36b to the horizontal edge 36a. Then the dividing line 34 is depicted along the horizontal edge 36a until vertex 44, when another vertical line segment is extended form the horizontal edge 36a to the horizontal edge 36b. Then the dividing line 34 is depicted along the horizontal edge 36b until vertex 45, when another vertical line segment is extended form the horizontal edge 36b to the horizontal edge 36a. Finally, the dividing line 34 is depicted along the horizontal edge 36a. Consequently, the dividing line 34 divides the polygonal planar 36 into a number of unit FIGS. 38, such as a triangle, rectangle, trapezoid, and parallelogram.

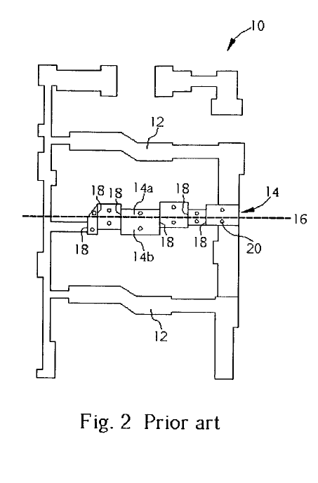

Since the dividing method according to the present invention uses a folded line composed of horizontal edges and vertical line segments to divide a polygonal planar, the polygonal planar is divided into a small number of unit figures. As shown in FIG. 2 and FIG. 3, the circuit pattern 30 of FIG. 3 is the same as the circuit pattern 10 of FIG. 2. The dividing method according to the present invention divides the circuit pattern 30 into seven unit figures. However, the prior art method divides the circuit pattern 10 into thirteen unit figures.

In brief, the method of dividing semiconductor integrated circuit patterns according to the present invention uses horizontal edges and vertical line segments formed at each vertex to divide a polygonal planar. Consequently, the polygonal planar is divided into a small number of unit figures. The disadvantage of the prior art method that results in more time spent when drawing the circuit pattern by a writer and causes the critical dimension to be hard to control is therefore improved.

Those skilled in the art will readily observe that numerous modifications and alterations of the device may be made while retaining the teachings of the invention. Accordingly, the above disclosure should be construed as limited only by the metes and bound of the appended claims.

What is claimed is:

1. A method of dividing a semiconductor integrated circuit pattern, the pattern comprising a plurality of cells with same shape and a polygonal planar positioned between each cell, the polygonal planar comprising two parallel horizontal edges and a plurality of vertexes, the method comprising:
depicting a division line to divide the polygonal planar positioned between each cell into a plurality of unit figures, the division line beginning along a horizontal edge of the polygonal planar, and when meeting with a vertex, the division line extending a vertical line segment from the horizontal edge to another horizontal edge.

2. The method of claim 1 wherein the unit figures comprise a triangle, rectangle, trapezoid, and parallelogram.

3. The method of claim 1 wherein the method of dividing a semiconductor integrated circuit pattern is used to convert circuit pattern data into input graphic data of a writer, so the writer can use the input graphic data for drawing the circuit pattern on a photo mask or a substrate.

4. A method of dividing a semiconductor integrated circuit pattern used in a data conversion system, the pattern comprising a plurality of cells with same shape and a polygonal planar positioned between each cell, the polygonal planar comprising two parallel horizontal edges and a plurality of vertexes, the method comprising:
depicting a division line to divide the polygonal planar positioned between each cell into a plurality of unit figures, the division line beginning along a horizontal edge of the polygonal planar, and when meeting with a vertex, the division line extending a vertical line segment from the horizontal edge to another horizontal edge;
wherein the data conversion system converts the divided circuit pattern into input graphic data, so a writer can use the input graphic data for drawing the circuit pattern on a workpiece.

5. The method of claim 4 wherein the unit figures comprise a triangle, rectangle, trapezoid, and parallelogram.

6. The method of claim 4 wherein the workpiece comprises a photo mask or a substrate.

7. A method of dividing a semiconductor integrated circuit pattern, the pattern comprising a plurality of cells with same shape and a polygonal planar positioned between each cell, the polygonal planar being composed of a plurality of unit figures and the unit figures being arranged sequentially and horizontally, the method comprising:
depicting a division line to divide the unit figures of the polygonal planar into at least two regions, and two adjacent unit figures being respectively divided into different regions.

8. The method of claim 7 wherein the unit figures comprise a triangle, rectangle, trapezoid, and parallelogram.

9. The method of claim 7 wherein the method of dividing a semiconductor integrated circuit pattern is used to convert circuit pattern data into input graphic data of a writer, so the writer can use the input graphic data for drawing the circuit pattern on a photo mask or a substrate.
